(19) United States
(12) Patent Application Publication
(10) Pub. No.: US 2012/0296966 A1
(43) Pub. Date: Nov. 22, 2012

(54) HIERARCHICALLY RELATED MOBILE USER GROUPS

(75) Inventor: Zhongwen Zhu, Saint-Laurent (CA)

(73) Assignee: TELEFONAKTIEBOLAGET L M ERICSSON (PUBL), Stockholm (SE)

(21) Appl. No.: 13/112,153

(22) Filed: May 20, 2011

(51) Int. Cl. G06F 15/16

(52) U.S. Cl. 709/204

(57) ABSTRACT

An application server supports mobile users in a wireless communication system. The application server includes a rule manager and a group controller. The rule manager obtains predefined rules that govern dynamic formation of logical mobile user groups which are hierarchically related to one another through parent-child relationships. In this regard, the predefined rules particularly establish conditions for child group formation and criteria for child group membership. The group controller dynamically forms child groups in accordance with these predefined rules. Specifically, the group controller dynamically forms any given child group from a member of a corresponding parent group to also include one or more other mobile users meeting criteria for membership in that child group, responsive to determining that conditions for forming the child group have been fulfilled. Advantageous uses of such groups include tracing the propagation of an electronic sales promotion or an infectious disease, or even social networking.

### TECHNICAL FIELD

The present invention generally relates to mobile user groups, and particularly relates to dynamically forming hierarchically related mobile user groups in accordance with predefined rules.

### BACKGROUND

Many businesses today distribute electronic advertisements in the form of sales promotions. Some sales promotions simply publicize prices that are available to every customer, while other promotions are more exclusive. These latter promotions often comprise free or paid coupons that require a customer to present the coupon in order to receive a special discount. With particular regard to a paid coupon, a business may further condition the special discount on a minimum number of customers purchasing that coupon. A coupon of this nature is thus appropriately referred to as a ‘group coupon.’

Businesses distribute sales promotions such as these for multiple reasons. The promotions of course stimulate potential customers into action, but they also often reveal information about those customers that is valuable for improving marketing and product/service offerings. Given these and other benefits of sales promotions, businesses maintain interest in understanding and correspondingly maximizing the effectiveness of the distribution approaches employed (e.g., by recognizing that distributing promotions to certain markets, in certain ways, yields greater benefits than others).

Known vehicles for distributing electronic promotions severely limit both the benefits of those promotions and the ability to understand the effectiveness of the distribution approaches employed. A business, an affiliated third party, or other official distributor directly distributes an electronic promotion, via a website or email, to a relatively small number of people who have provided the distributor with information about themselves (e.g., name, contact information, etc.). These “known” recipients then relay the promotion to other recipients entirely unknown to the official distributor (e.g., in the case of a group coupon, to help generate the required number of purchases). This relaying from person to person without the distributor's knowledge continues “virally” and certainly exposes the promotion to a greater number of potential customers. But the official distributor cannot collect information about unknown recipients until they actually act on the promotion and become a customer. And even then, the official distributor does not know exactly how those customers received the promotion. The official distributor thus misses out on valuable information that describes potential customers and the effectiveness of its distribution approach.

### SUMMARY

One or more embodiments herein effectively trace the propagation of an electronic promotion from mobile user to mobile user in a wireless communication system, and thereby provide the official distributor of the promotion with information that describes the mobile user recipients and the distribution's effectiveness. As explained more fully below, these embodiments employ an application server which dynamically forms logical, hierarchically related mobile user groups that trace the propagation of an electronic promotion. Of course, the utility of such mobile user groups is not limited to tracing of electronic promotions. In other embodiments, the groups may track the propagation of an infectious disease or even facilitate social networking.

More particularly, an application server according to one or more embodiments supports mobile users in a wireless communication system. The application server includes a rule manager and a group controller. The rule manager is configured to obtain predefined rules that govern dynamic formation of logical mobile user groups (i.e., logical groups of mobile users) which are hierarchically related to one another through parent-child relationships. In this regard, the predefined rules particularly establish conditions for child group formation and criteria for child group membership. The group controller is configured to dynamically form child groups in accordance with these predefined rules. Specifically, the group controller is configured to dynamically form any given child group from a member of a corresponding parent group to also include one or more other mobile users meeting criteria for membership in that child group, responsive to determining that conditions for forming the child group have been fulfilled.

The specific conditions or criteria established by the predefined rules may depend on the particular use for which the mobile user groups are being formed. Some non-limiting, example uses are discussed below, but as a general proposition the formation conditions and/or membership criteria for a child group relate in many cases to one or more characteristics of the parent group member from which the child group is formed (i.e., the child group's forming member). Such characteristics may include, for instance, the parent group member's location. Regardless, in some embodiments, the group controller is configured to monitor these one or more characteristics of the parent group member, in order to dynamically determine whether conditions for forming the child group have been fulfilled. Responsive to determining that the conditions have been fulfilled, the group controller automatically forms the child group.

In alternative embodiments the group controller does not perform such monitoring or automatically form a child group. Instead, the group controller only forms a child group if requested to do so by a parent group member. In this regard, the group controller is configured to receive a request to form the child group from the parent group member. Responsive to receiving this request, the group controller determines whether conditions for forming the child group have been fulfilled by evaluating the one or more characteristics of the requesting parent group member. If the conditions have been fulfilled, the group controller forms the child group.

Many embodiments, for example those useful for tracing the propagation of an electronic promotion or for social networking, have predefined rules that are location-based. These rules establish conditions for forming a child group that include a parent group member being located within a predefined geographical region (which may be defined in either absolute terms or relative terms). The rules also establish criteria for membership in the child group formed that include a mobile user being within a predefined proximity to that parent group member. In some embodiments, the membership criteria further include a mobile user being within such proximity for at least a predefined minimum amount of time or during one or more predefined windows of time, or both.

In still other embodiments, child group formation conditions do not include a parent group member being located within a predefined geographical region. Instead, child group formation conditions include a parent group member being within a predefined proximity to another mobile user for at least a predefined minimum amount of time. As demonstrated, these embodiments prove particularly useful for tracking of infectious diseases.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram that illustrates a wireless communication system which includes a plurality of mobile users and that also illustrates an application server configured to support those mobile users, according to one or more embodiments herein.

FIG. 2 is a block diagram of an application server according to one or more embodiments.

FIG. 3 is a hierarchy schematic illustrating the hierarchical relationship between exemplary logical mobile user groups, as formed by an application server according to some embodiments.

FIG. 4 illustrates one example of embodiments that include parent group member location as a condition for child group formation, and mobile user proximity as criteria for child group membership.

FIG. 5 illustrates one example of embodiments that include mobile user proximity as a condition for child group formation.

FIG. 6 is a logic flow diagram of a method implemented by the application server depicted in FIG. 2, according to one or more embodiments.

### DETAILED DESCRIPTION

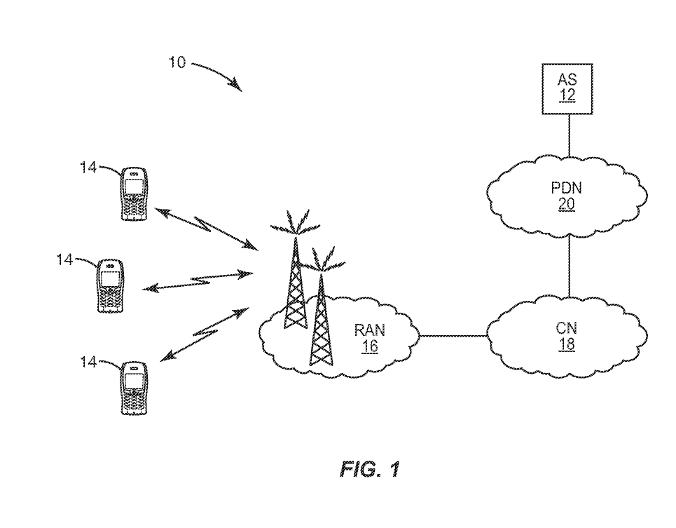

FIG. 1 illustrates a wireless communication system 10 that facilitates communication between a plurality of mobile users 14 and an application server 12 configured to support those mobile users 14. The wireless communication system 10 as shown includes a radio access network (RAN) 16 and a core network (CN) 18. The RAN 16 provides the mobile users 14 with access to the CN 18 over radio resources. The CN 18 correspondingly connects the RAN 16 to the AS 12, e.g., via an external packet data network (PDN) 20 such as the Internet. Alternatively, the application server 12 may be located within the CN 18 itself.

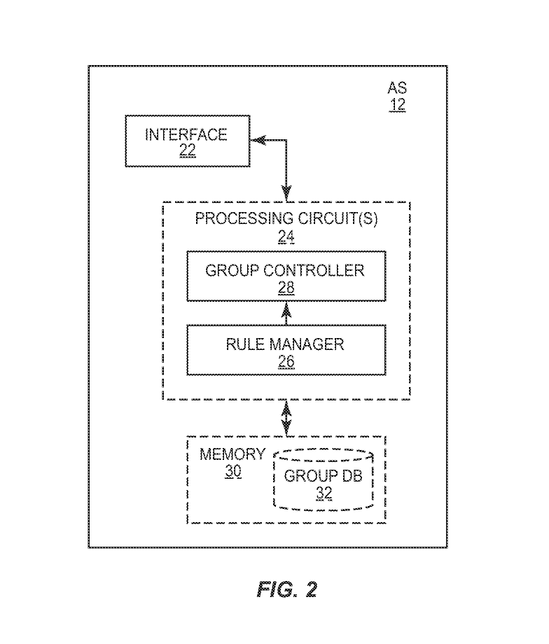

FIG. 2 depicts details of the application server 12 according to one or more embodiments. As shown in FIG. 2, the application server 12 includes an interface 22 configured to communicatively couple the server 12 to the mobile users 14 via the wireless communication system. The application server 12 also includes one or more processing circuits 24. Notably, the processing circuits 24 include a rule manager 26 and a group controller 28. The rule manager 26 is configured to obtain predefined rules that govern dynamic formation of logical mobile user groups (i.e., logical groups of mobile users 14) which are hierarchically related to one another through parent-child relationships. In this regard, the predefined rules particularly establish conditions for child group formation and criteria for child group membership. The group controller 28 is configured to dynamically form child groups in accordance with these predefined rules. Specifically, the group controller 28 is configured to dynamically form any given child group from a member of a corresponding parent group to also include one or more other mobile users meeting criteria for membership in that child group, responsive to determining that conditions for forming the child group have been fulfilled.

In one or more embodiments, forming such groups entails logically grouping unique indexes associated with mobile users 14 together and relating those groups to one another in a database or other data structure, e.g., maintained at the application server 12 in memory 30. As shown, for instance, the application server 12 includes a group database (DB) 32. This group DB 32 in a simplified example includes a number of tables, including a group table, a mobile user table, and a mobile user group table.

The mobile user table relates mobile users 14, as identified by mobile telephone number, name, or the like, to unique mobile user indexes (i.e., keys). The group table includes unique indexes for formed groups and relates those indexes to one another in parent-child relationships. A record for any given group in the group table may include, for example, a unique index for that group, a unique index for that group's parent group (or some other entry if the group is the root parent group and thus has no parent group), and a set of one or more unique indexes for child groups that directly descend from the group. The mobile user group table may correspondingly relate the unique mobile user indexes to the unique group indexes in accordance with group membership. Forming a new group in this case thus entails creating a new record in the group table of the group DB 32, based on the parent-child relationships of the new group, and creating one or more new records in the mobile user group, based on the mobile user membership of the new group.

Irrespective of the particular approach used to actually form the logical mobile user groups, the predefined rules in some embodiments also establish formation conditions and membership criteria for an initial, or root, parent group, from which the child groups mentioned above descend. In these embodiments, the group controller 28 dynamically forms the root parent group to include mobile users meeting criteria for membership in the root parent group, responsive to determining that conditions for forming the root parent group have been fulfilled. The child group formation conditions and membership criteria discussed above may be the same as (i.e., be inherited from) those of this root parent group, or be separately defined by the predetermined rules. In other embodiments, the predefined rules actually pre-form the root parent group (i.e., no conditions need be fulfilled for its formation). In this case, the rules explicitly define the membership of the root parent group.

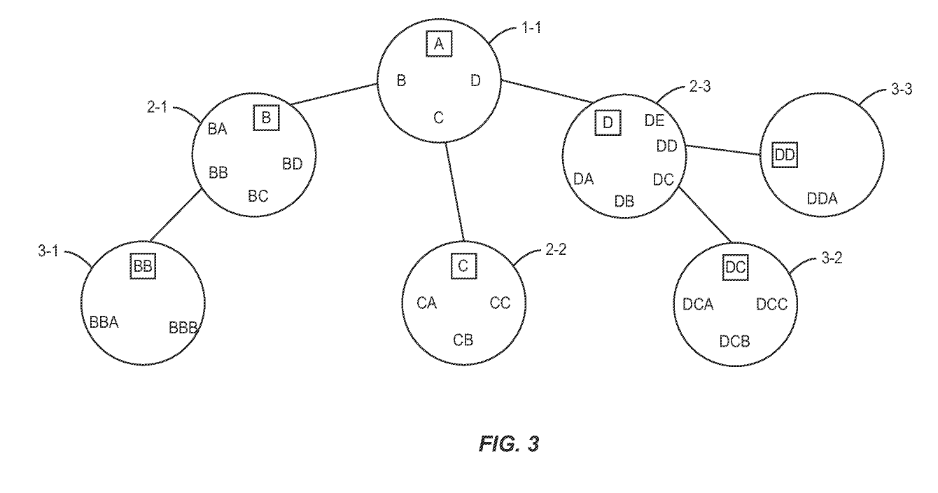

FIG. 3 graphically illustrates dynamic formation of logical mobile user groups in the context of an example. In FIG. 3, the group controller 28 has formed a root parent group 1-1 (either dynamically responsive to formation conditions being fulfilled or as pre-formed by the predefined rules). The root parent group 1-1 as formed includes four mobile users, denoted here for convenience as mobile users A, B, C, and D. Mobile user A has been singled out in this example as being the so-called forming member of the group 1-1; that is, the member from which the group 1-1 was formed.

The predefined rules obtained by the rule manager 26 govern the dynamic formation of child groups 2-1, 2-2, and 2-3, which when formed directly descend from the root parent group 1-1 (here, X-Y indicates a group at hierarchical level X that is uniquely identified within that level by the number Y). For instance, with respect to child group 2-1, the rules establish the conditions under which group 2-1 is formed and the criteria for membership in group 2-1. Responsive to determining that conditions for forming child group 2-1 have been fulfilled, the group controller 28 dynamically forms child group 2-1 from mobile user B (as the forming member). In doing so, the group controller 26 also determines that mobile users BA, BB, BC, and BD meet the criteria for membership in the child group 2-1. Group 2-1 therefore includes mobile users B, BA, BB, BC, and BD. Note that even when group 2-1 is formed to include mobile user B as its forming member, the mobile user B still remains a member of the root parent group 1-1.

The predefined rules in some embodiments establish similar formation conditions and membership criteria for child groups 2-2 and 2-3, which are formed respectively from mobile user C and mobile user D. In fact, in some embodiments, the predefined rules establish the same formation conditions and/or the same membership criteria for forming child groups at the same hierarchical level (albeit from different mobile users).

Groups 2-1 and 2-3 were referred to as child groups above because they descend from the root parent group 1-1. Indeed, as used herein, any group descending from the root parent group 1-1 is in a general sense a child group. This includes groups 3-1, 3-2, and 3-3, which when formed in this example descend from the root parent group 1-1 indirectly via groups 2-1 and 2-3. In this regard, groups 2-1 and 2-3 may also be referred to as being intervening parent groups (or just simply parent groups) with respect to child groups 3-1, 3-2, and 3-3.

Dynamic formation of these child groups 3-1, 3-2, and 3-3 is also governed by the predefined rules. In some embodiments, the formation conditions and membership criteria for child groups 3-1, 3-2, and 3-3 are the same as those established for child groups 2-1, 2-2, and 2-3. In other embodiments, the formation conditions and membership criteria for child groups 3-1, 3-2, and 3-3 are different from those established for child groups 2-1, 2-2, and 2-3. That is, the predefined rules establish different formation conditions and/or different membership criteria for groups at different hierarchical levels.

The formation conditions and membership criteria for child groups have been discussed above, for convenience, as being the same regardless of when the child groups are formed. In other embodiments, however, the predefined rules establish formation conditions and/or membership criteria that may be different depending on the particular time at which child groups are formed. In this case, the rules may establish different conditions for forming child groups during different periods of time (i.e., during one period of time, certain conditions need be fulfilled in order to form a child group, while during another period of time, other conditions need be fulfilled). The rules may alternatively or additionally establish different criteria for membership in child groups formed during different periods of time (i.e., if a child group is formed during one period of time, mobile users need to meet certain criteria in order to be members of that group, while if a child group is formed during another period of time, mobile users need to meet different criteria in order to be members of the group). Note that this timing dependency, in at least some embodiments, exists not due to dynamic modification of the predefined rules, but rather predefined timing conditions specified by the rules. Thus, the application server 12 in these embodiments evaluates the current time and determines which rules to apply at the current time.

The formation conditions and membership criteria for child groups have also been discussed above very generally, without describing the particular conditions or criteria themselves. Indeed, the specific conditions or criteria established by the predefined rules may depend on the particular use for which the mobile user groups are being formed. Some non-limiting, example uses are discussed below, but as a general proposition the formation conditions and/or membership criteria for a child group relate in many cases to one or more characteristics of the parent group member from which the child group is formed (i.e., the child group's forming member). Such characteristics may include, for instance, the parent group member's location. Regardless, in some embodiments, the group controller 28 is configured to monitor these one or more characteristics of the parent group member, in order to dynamically determine whether conditions for forming the child group have been fulfilled. Responsive to determining that the conditions have been fulfilled, the group controller 28 automatically forms the child group.

In alternative embodiments the group controller 28 does not perform such monitoring or automatically form a child group. Instead, the group controller 28 only forms a child group if requested to do so by a parent group member. In this regard, the group controller 28 is configured to receive a request to form the child group from the parent group member. Responsive to receiving this request, the group controller 28 determines whether conditions for forming the child group have been fulfilled by evaluating the one or more characteristics of the requesting parent group member. If the conditions have been fulfilled, the group controller 28 forms the child group.

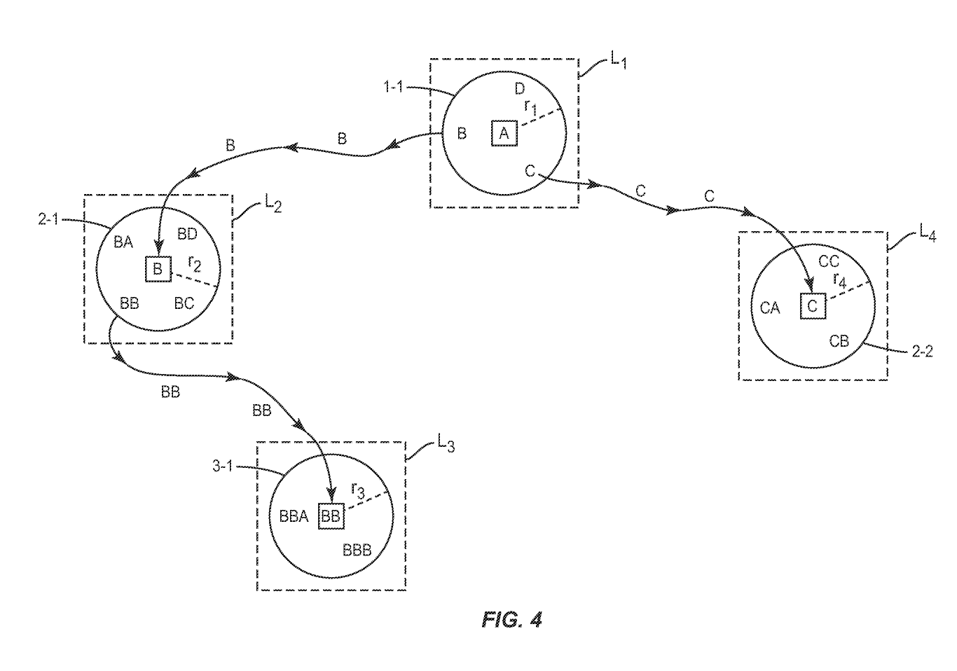

The example in FIG. 4 illustrates embodiments where conditions for forming a child group include a parent group member being located within a predefined geographical region (which may be defined in either absolute terms or relative terms). The example also illustrates embodiments where criteria for membership in the child group formed include a mobile user being within a predefined proximity to that parent group member. Non-limiting example uses of these embodiments, as explained below, include tracing the propagation of an electronic promotion and social networking.

In FIG. 4, the predefined rules establish conditions for forming child groups 2-1 and 2-2 to include a member of the root parent group 1-1 being located within predefined geographical regions L₂ or L₄, which are shown here as being absolute locations. The predefined rules also establish criteria for membership in those child groups 2-1 and 2-2 to include a mobile user being within a radius r₂ or r₄ of the corresponding parent group member.

With the rules defined in this way, mobile user B in the example moves away from the root parent group 1-1 towards geographical region L₂. When mobile user B arrives at L₂, the group controller 28 dynamically forms child group 2-1 from that user B. In some embodiments, the group controller 28 monitors the location of mobile user B and automatically forms child group 2-1 when user B arrives at L₂. In other embodiments, mobile user B sends a request to the group controller 28 upon arriving at L₂, and responsive to this request the group controller 28 verifies the location of user B as being at L₂ and forms the child group 2-1. Regardless, the group controller 28 forms the child group 2-1 to include mobile user B as well as other mobile users within radius r₂ of mobile user B, namely mobile users BA, BB, BC, and BD. Similarly, mobile user C moves away from the root parent group 1-1 towards geographical region L₄, whereupon the group controller 28 dynamically forms child group 2-2 to include mobile user C as well as other mobile users CA, CB, and CC within radius r₄ of mobile user C. In at least some embodiments, the membership criteria for child groups at the same hierarchical level is the same (i.e., radius r₄ is the same as radius r₂), despite the formation conditions for those child groups being different (i.e., L₂ is different from L₄).

Note that while the formation of child groups 2-1 and 2-2 were described above as being conditional on mobile users B and C moving to L₂ and L₄, respectively, the predefined rules in some embodiments are generic with regard to the particular parent group members that move to those locations L₂ and L₄. In this case, for example, the rules simply condition formation of a child group being formed on any member of the root parent group 1-1 moving to L₂, whether that member be user A, B, C, or D. The group controller 28 may however restrict the number of child groups formed at L₂, in the case that more than one member of the root parent group 1-1 moves to that location. If this occurs, the group controller 28 may assign one parent group member (e.g., the first one at L₂) to be the forming member of the child group and treat each of the other parent group members as any other mobile user (i.e., include them as members in the child group if they meet the criteria for membership in that group).

Returning back to the specific example of FIG. 4, the predefined rules also establish formation conditions and membership criteria for child groups at other hierarchical levels, such as child group 3-1. The conditions and/or criteria may simply be inherited from (i.e., be the same as) those established for other hierarchical levels, or may be different. As shown, membership criteria for child group 3-1 may be the same as or different from the criteria for group 2-1, depending on whether the predefined rules define r₃ to be the same as or different from r₂. But the conditions for formation of child group 3-1 are different in the sense that formation is conditioned on a mobile user being located within geographical region L₃, which is distinct from region L₂.

Note of course that the formation conditions for child group 3-1 may be generic with regard to which mobile user must be located within L₃ in order for the group to be formed. The conditions may also be generic with regard to which group such a mobile user belongs. For example, as shown in FIG. 4, mobile user BB as a member of group 2-1 moved to L₃ and formed group 3-1 as a child group of group 2-1. However, the predefined rules may have equally permitted mobile user D as a member of group 1-1 to move to L₃ and form group 3-1 as a child group of group 1-1. In this case, the rules do not specifically require that a member of a particular group move to L₃ in order for group 3-1 to be formed.

Note also that the predefined rules may additionally establish conditions for forming the root parent group 1-1 and criteria for membership in that group 1-1. As shown, such conditions include a mobile user (e.g., mobile user A) being located within L₁, and the membership criteria include a mobile user being within a radius r₁ of user A. Nonetheless, in other embodiments, the root parent group 1-1 may be arbitrarily specified by the predefined rules.

Further note that child group membership criteria in the above embodiments may include other criteria in addition to proximity to a parent group member. For instance, membership criteria may include a mobile user being within such proximity for at least a predefined minimum amount of time or during one or more predefined windows of time, or both.

The embodiments illustrated by FIG. 4, whereby child groups are dynamically formed as parent group members geographically disperse, prove particularly useful for tracing the propagation of a broadcast message (e.g., an electronic promotion). Consider a scenario where region L₁ represents a shopping mall, and mobile users A-D at that shopping mall are each known to the application server 12. Mobile user A as a sales associate demonstrates a product or service to nearby mobile users B, C, and D as potential customers.

At the end of the demonstration, mobile user A sends a request to the application server 12 to form group 1-1. Responsive to this request, the group controller 28 determines that mobile users B, C, and D meet the criteria for membership in the group 1-1. In some embodiments, this simply means that users B, C, and D are within a predefined proximity to user A (and therefore presumably saw the demonstration). In other embodiments, this means that users B, C, and D were within such proximity for at least a minimum amount of time (and therefore saw at least a certain portion, e.g., half, of the demonstration). Regardless, responsive to the group 1-1 being formed, a messenger (not shown) at the application server 12 sends a broadcast message to the members of the group 1-1. This broadcast message may include, for instance, an electronic promotion for the product or service just demonstrated by user A. Alternatively, the broadcast message may simply include a link to such a promotion.

As members of group 1-1 disperse from the shopping mall at L₁, the members move to other locations L₂, L₄ specified by the predefined rules (e.g., other shopping malls, restaurants, etc.). At those locations, the predefined rules permit the members to form child groups 2-1 and 2-2, in order to propagate the broadcast message to additional mobile users (e.g., BA, BB, BC, BD, CA, CB, CC . . . ). In this regard, responsive to dynamically forming a child group, the messenger propagates to that child group the same broadcast message that was previously sent to the parent group 1-1. As this process iterates, the group structure traces the propagation of the broadcast message.

This feature proves particularly advantageous in embodiments where the message is an electronic promotion. Because the promotion is broadcast through the application server 12, and since each mobile user is known to the server 12, the server 12 can provide comprehensive information about (1) the mobile users who received the promotion; and (2) the effectiveness of the promotion's distribution. Moreover, because the server 12 can track the propagation of the electronic promotion from user to user, the server 12 can provide individualized information about the extent to which any given user has propagated the promotion (e.g., in general terms of how many child groups have been formed through or because of that user, or in more specific terms of how many other users have received the promotion through the user). This information can serve as the basis for an incentivized propagation system, whereby users are rewarded for the extent to which they propagate an electronic promotion. In the case of a group coupon, such reward may be above and beyond the reward inherent in the propagation of that coupon to enough people for it to be honored. The reward may be, for instance, an additional discount above the group discount.

Another type of reward may allow a mobile user that caused an electronic promotion to be extensively propagated to many child groups, to send that promotion (or future electronic promotions) to additional groups. That is, in some embodiments, the messenger by default only permits a mobile user to propagate an electronic promotion to child groups formed from that user (or any child group descending therefrom). But, if the mobile user forms some minimum number of child groups, or a minimum number of users receive the promotion because of that user, the messenger permits the user to propagate the electronic promotion to additional groups. These additional groups may include the parent group, sibling groups, or any group in the hierarchy.

The embodiments illustrated by FIG. 4 also prove useful for location-based social networking. Consider a scenario where regions L₁, L₂, L₃, and L₄ represent night clubs, bars, pubs, or other such venues. In this scenario, group formation may facilitate communication among mobile users involved in a so-called “pub crawl,” whereby different groups of users crawl from venue to venue. As shown, for instance, group 1-1 is formed to include mobile users A, B, C, and D that are located at L₁. As members of this group 1-1, the users may communicate with one another by sending broadcast messages to the group via the application server's messenger. In some embodiments, the users may even communicate by sending dedicated messages to one another, on the assumption that by being at the same location those users have formed an individual social connection. Regardless, a member of group 1-1 may in an example situation broadcast a message to the group that informs the group that he or she is leaving L₁ to go to another venue.

In this example, mobile users B and C disperse to different locations, L₂ and L₄. The users B and C nonetheless remain connected as members of group 1-1, and can still communicate with one another and with other members of the group 1-1 in the same way as before. Having dispersed, mobile user B forms child group 2-1 at L₂, and user C forms child group 2-2 at L₄. In at least some embodiments, members of parent group 1-1 may communicate with child groups 2-1 and 2-2 via the messenger on a group basis. For instance, user D may communicate with members of groups 2-1 or 2-2 by sending a broadcast message to that group. In one embodiment, any member of child group 2-1 or 2-2 may likewise send a broadcast message to the parent group 1-1. Note that the messenger restricts such communication to being on a group basis, rather than on an individual basis, on the assumption that the social connections have been formed on a group basis, not an individual basis. Indeed, the members of the child group 2-2 (with the exception of the forming member, user C) have never been at the same location as a member of the parent group 1-1, and thus can not have formed an individual connection with any of those members.

In some embodiments, the messenger similarly permits communication on a group basis between sibling groups, etc. In this case, mobile user B, or other members of group 2-1, may communicate with members of group 2-2 by sending that group a broadcast message. Likewise, user C, or other members of group 2-2, may communicate with members of group 2-1 by sending that group a broadcast message. Such communication socially connects different groups of mobile users that are related to one another through users B and C.

FIG. 4 as discussed above has illustrated particular embodiments whereby child group formation conditions include a parent group member being located within a geographical region that is defined in absolute terms (e.g., a particular shopping mall or venue). However, in other embodiments this geographical region is defined in relative terms. In this case, child group formation conditions may include a parent group member being located at least a minimum distance from the parent group. The child group formation conditions may additionally or alternatively include a parent group member being located at least a predefined distance from other, already formed sibling groups (i.e., child groups of the same parent). The child group membership criteria may be similar to those discussed above, i.e., proximity based.

Such embodiments prove particularly useful for marketing products according to a so-called “party plan”, whereby product are marketed through a social event, which is usually hosted at a person's home. The host of the event is usually given free gifts, special discounts, or a portion of the proceeds from the event, as an incentive to host. Those attending the event are usually given a token item of nominal value as an incentive to attend, and can thereafter host events of their own.

In this context, an original host of an event (or an official sales professional demonstrating the product at the event) may send a request to the application server 12 to form the root parent group. Responsive to the request, the group controller 28 forms the parent group to include those mobile users attending the event. With the parent group formed, the host or official sales professional can send product ordering information (or promotions) to the group members via the application server 12. The application server 12 may also record product purchases resulting from the event.

As those mobile users disperse and host events of their own, they request the formation of child groups, in order to propagate the product ordering information to additional mobile users. In one possible implementation, the child groups are formed when the events are hosted at least a minimum distance from the original host (i.e., the parent group location). In some embodiments, the hosted events must also be at least some minimum distance from one another in order for the child groups to be formed. As this process iterates, the group structure traces the propagation of events hosted for certain products in terms of the location of those events as well as the mobile users attending and hosting those events. Based on this information, an incentive program may be offered to mobile users in much the same way as discussed above, to reward those mobile users that host a lot of events and/or produce a lot of product purchases.

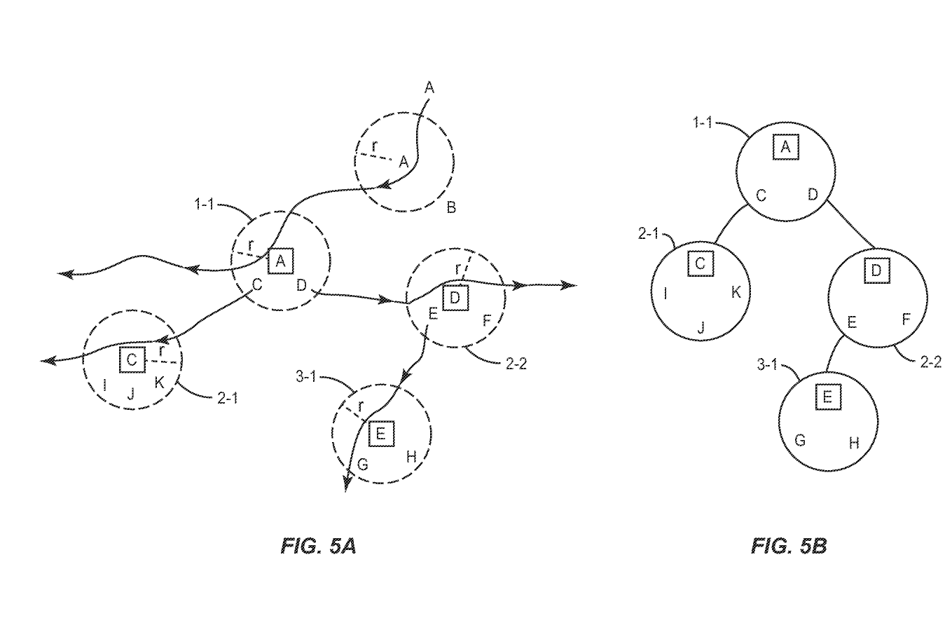

The example in FIGS. 5A-5B illustrates still further embodiments. Unlike the above embodiments, child group formation conditions in these embodiments do not include a parent group member being located within a predefined geographical region. Instead, child group formation conditions include a parent group member being within a predefined proximity to another mobile user for at least a predefined minimum amount of time. As demonstrated, these embodiments prove particularly useful for tracking of infectious diseases. Especially when used in this context, the group controller 28 monitors the location of an infected mobile user and the location of nearby mobile users, for determining whether the infected mobile user moves within the defined proximity of other users for the minimum amount of time. If so, the group controller 28 automatically forms a group including the infected users.

Consider FIG. 5A. In FIG. 5A, a mobile user A is infected with a disease that is contagious. The disease spreads to mobile users that are within a certain radius r for at least a minimum amount of time. In order to track the disease as it spreads, the predefined rules establish group formation conditions commiserate with these spreading characteristics; that is, the conditions include a mobile user being within a radius r of an infected mobile user for at least the minimum amount of time.

Following the example, infected mobile user A moves near mobile user B, but not within radius r. So no group is formed. But, user A thereafter moves within radius r of mobile users C and D, and stays within that proximity for the defined minimum amount of time. Responsive to these conditions being fulfilled, the group controller 28 automatically forms the root parent group 1-1 shown in FIG. 5B. This group 1-1 includes mobile users C and D as members, with user A of course being the forming member.

Users C and D, now infected with the disease, disperse. The group controller 28 monitors the location of the users and, responsive to the same conditions being fulfilled with respect to those users, automatically forms child groups 2-1 and 2-2. This process iterates as the disease spreads, to ultimately form the group structure illustrated in FIG. 5B. This group structure thus traces the propagation of the infectious disease.

The group structure and the trace that it provides may be used in any number of ways. The structure in some embodiments may be used passively by health organizations simply to understand transmission vectors of the disease. In other embodiments, the structure may be used to actively warn mobile users about their actual or potential exposure to the disease and to attempt to stop the spread of the disease. For instance, the messenger may broadcast a message to a newly formed group informing each member of the group that he or she may have just been exposed to an infectious disease, should quarantine himself or herself, and should seek medical attention.

To prevent or mitigate abuse of mobile user groups, certain embodiments herein provide enhanced privacy to mobile users. For example, in some embodiments, mobile users may opt-out of group formation and thereby avoid being included as members of a group, even if they otherwise meet the criteria for membership. So, if groups are formed for broadcasting electronic promotions, mobile users that opt out will not receive those promotions, and if groups are formed for socially connecting pub crawlers, mobile users that opt out will not receive messages broadcast to the formed groups. In other embodiments, privacy is enhanced by restricting the amount or kind of information about a mobile user that is visible to other mobile users. For example, in some embodiments, the application server 12 provides a mobile user with information about other mobile users included in the same group(s) as that user and/or included in child groups descending from those groups. In privacy enhanced embodiments, this information may be limited to non-identifying or anonymous information (e.g., a user name, rather than a mobile telephone number).

In at least some embodiments, mobile users are known to the application server 12 by nature of those users having registered with the server 12. Such registration may entail, for instance, providing the application server 12 with identifying information (e.g., mobile telephone number, name, etc.) and may also entail installing an application supported by the server 12. These embodiments apply especially to cases where the application server 12 is not hosted by the mobile users' wireless operator (i.e., carrier), and may thus reside outside of the system's CN 18. In this case, the application server 12 can easily support mobile users across wireless carriers, but may not know about those users until the users explicitly register with the server 12.

In other embodiments, the server 12 resides in the CN 18 and is hosted by the wireless operator. In this case, mobile users may be known to the application server 12 simply by nature of those users being supported by the wireless operator. These embodiments may limit the application server 12 to mobile users of a particular wireless operator, but may not require mobile users to explicitly register with the server 12. Thus, in the example of FIG. 4, an inherent criterion for membership in a group may be that a mobile user is supported by a particular wireless operator (since otherwise the application server 12 may not even know about the existence of that mobile user).

Those skilled in the art will of course appreciate that the above embodiments have been described as non-limiting examples, and have been simplified in many respects for ease of illustration. For instance, although in the examples only a limited number of child groups were illustrated, the predefined rules may permit any number of child groups and any number of hierarchical levels to be formed. In other embodiments, the predefined rules may specify a maximum number of child groups (either in absolute terms as the maximum number of child groups descending from the root parent group or in relative terms as the maximum number of child groups descending from any given parent group) and/or a maximum number of hierarchical levels.

Also, embodiments above have for ease of illustration simply explained that the rule manager 26 obtains the predefined rules. In some embodiments, this entails retrieving the predefined rules from memory 30 at the application server 12. In other embodiments, it entails retrieving the predefined rules from another node via the interface 22 or another processing circuit 24 not shown. For example, in at least one embodiment, the rules are predefined by an administrator via a web interface to a web server (not shown). The administrator may be the official distributor of an electronic promotion, a health organization, etc. Regardless, the rule manager 26 may retrieve the rules from such a web server, as defined by the administrator, or act as the web server itself and thereby retrieve the rules from the administrator directly. In this way, the rules are preset in advance of dynamic child group formation.

Further, embodiments have not been described in the context of any particular wireless communication standard. Indeed, no particular communication interface standard is necessary for practicing the present invention. That is, the wireless communication system 10 may be any one of a number of standardized system implementations such as Wideband CDMA (WCDMA), High Speed Packet Access (HSPA), Long Term Evolution (LTE), LTE-Advanced, CDMA2000, or the like.

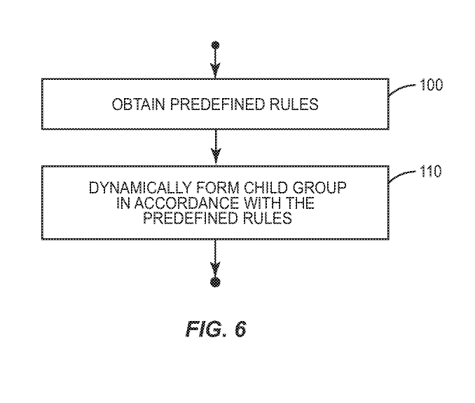

With the above variations and modifications in mind, those skilled in the art will appreciate that the application server 12 herein is generally configured to perform the processing illustrated in FIG. 6. In FIG. 6, processing includes obtaining predefined rules (Block 100). As explained above, these predefined rules govern dynamic formation of logical mobile user groups which are hierarchically related to one another through parent-child relationships. In this regard, the rules establish conditions for child group formation and criteria for child group membership. Processing further includes dynamically forming any given child group in accordance with those rules (Block 110). Specifically, such processing includes forming any given child group from a member of a corresponding parent group to also include one or more other mobile users 14 meeting criteria for membership in that child group, responsive to determining that conditions for forming the child group have been fulfilled.

Those skilled in the art will also appreciate that the various “circuits” described may refer to a combination of analog and digital circuits, including one or more processors configured with software stored in memory 30 and/or firmware stored in memory 30 that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Thus, those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method implemented by an application server supporting mobile users in a wireless communication system, the method comprising:
obtaining predefined rules that govern dynamic formation of logical mobile user groups which are hierarchically related to one another through parent-child relationships, said rules establishing conditions for child group formation and criteria for child group membership; and
dynamically forming any given child group from a member of a corresponding parent group to also include one or more other mobile users meeting criteria for membership in that child group, responsive to determining that conditions for forming the child group have been fulfilled.

2. The method of claim 1, wherein said conditions for forming the child group relate to one or more characteristics of said member of the parent group.

3. The method of claim 2, further comprising monitoring said one or more characteristics for dynamically determining whether conditions for forming the child group have been fulfilled, and, responsive to determining that those conditions have been fulfilled, automatically forming the child group.

4. The method of claim 1, further comprising receiving a request to form the child group from said member of the parent group, and, responsive to receiving the request, determining whether conditions for forming the child group have been fulfilled by evaluating said one or more characteristics.

5. The method of claim 1, wherein said conditions for forming the child group include said member of the parent group being located within a predefined geographical region.

6. The method of claim 1, wherein said conditions for forming the child group include said member of the parent group being within a predefined proximity to another mobile user for at least a predefined minimum amount of time.

7. The method of claim 1, wherein said criteria for membership in the child group include a mobile user being within a predefined proximity to said member of the parent group.

8. The method of claim 1, wherein said criteria for membership in the child group include a mobile user meeting one or more other criteria either for at least a predefined minimum amount of time or during one or more predefined windows of time, or both.

9. The method of claim 1, wherein said rules establish at least one of:
different conditions for forming child groups at different hierarchical levels; and
different criteria for membership in child groups at different hierarchical levels.

10. The method of claim 1, wherein said rules establish at least one of:
different conditions for forming child groups during different periods of time; and
different criteria for child groups formed during different periods of time.

11. The method of claim 1, further comprising, responsive to dynamically forming the child group, propagating to that child group a broadcast message previously sent by the application server to the parent group, said groups thereby tracing the propagation of that broadcast message.

12. An application server supporting mobile users in a wireless communication system, the application server comprising:
a rule manager configured to obtain predefined rules that govern dynamic formation of logical mobile user groups which are hierarchically related to one another through parent-child relationships, said rules establishing conditions for child group formation and criteria for child group membership; and
a group controller configured to dynamically form any given child group from a member of a corresponding parent group to also include one or more other mobile users meeting criteria for membership in that child group, responsive to determining that conditions for forming the child group have been fulfilled.

13. The application server of claim 12, wherein said conditions for forming the child group relate to one or more characteristics of said member of the parent group.

14. The application server of claim 13, wherein the group controller is configured to monitor said one or more characteristics for dynamically determining whether conditions for forming the child group have been fulfilled, and, responsive to determining that those conditions have been fulfilled, to automatically form the child group.

15. The application server of claim 12, wherein the group controller is configured to receive a request to form the child group from said member of the parent group, and, responsive to receiving the request, to determine whether conditions for forming the child group have been fulfilled by evaluating said one or more characteristics.

16. The application server of claim 12, said conditions for forming the child group include said member of the parent group being located within a predefined geographical region.

17. The application server of claim 12, wherein said conditions for forming the child group include said member of the parent group being within a predefined proximity to another mobile user for at least a predefined minimum amount of time.

18. The application server of claim 12, wherein said criteria for membership in the child group include a mobile user being within a predefined proximity to said member of the parent group.

19. The application server of claim 12, wherein said criteria for membership in the child group include a mobile user meeting one or more other criteria either for at least a predefined minimum amount of time or during one or more predefined windows of time, or both.

20. The application server of claim 12, wherein said rules establish at least one of:
different conditions for forming child groups at different hierarchical levels; and
different criteria for membership in child groups at different hierarchical levels.

21. The application server of claim 12, wherein said rules establish at least one of:
different conditions for forming child groups during different periods of time; and
different criteria for child groups formed during different periods of time.

22. The application server of claim 12, further comprising a messenger configured, responsive to the group controller dynamically forming the child group, to propagate to that child group a broadcast message previously sent by the messenger to the parent group, said groups thereby tracing the propagation of that broadcast message.
